(19) United States
(12) Patent Application Publication
(10) Pub. No.: US 2018/0220197 A1
(43) Pub. Date: Aug. 2, 2018

(54) IDENTIFYING SKIPPED OFFERS OF INTEREST

(71) Applicant: International Business Machines Corporation, Armonk, NY (US)

(72) Inventors: Jeremy A. Greenberger, Raleigh, NC (US); Jana H. Jenkins, Raleigh, NC (US)

(21) Appl. No.: 15/417,282

(22) Filed: Jan. 27, 2017

(51) Int. Cl. H04N 21/81; H04N 21/4147; H04N 21/488; G06Q 30/02

(52) U.S. Cl. CPC H04N 21/812; H04N 21/4147; G06Q 30/0269; H04N 21/488; H04N 21/8126

(57) ABSTRACT

Approaches presented herein enable representation of missed offers in a prerecorded video comprising a primary content and offer content that has been skipped by a user. More specifically, when the user plays the prerecorded video and initiates an action to skip the offer content, an offer representation tool identifies the subject matter of offers being skipped and generates an alternative representation of the skipped offer including a summary of the subject matter. The offer representation tool then displays the alternative representation of the offer to the user. The displaying the alternative representation can be based on whether a user profile, generated by the offer representation tool and describing preferences of the user, indicates that the skipped offer is potentially of interest to the user.

### TECHNICAL FIELD

The present invention relates generally to providing information from a video and, more specifically, to processing a video for advertisement information and presenting an alternative representation of that information to a user.

### BACKGROUND

In the 1980s and 1990s, videocassette recorders (VCRs) were a common feature in many homes. VCRs were used to record analog audio and analog video from a broadcast television or other source on a removable, magnetic tape videocassette, and to play back the recording. In addition to using a VCR to play back prerecorded tapes, many homeowners would program their VCR to record a television program on a blank tape to play back at a more convenient time, a practice commonly referred to as timeshifting. In more recent years, the digital video recorder (DVR) has largely replaced the analog VCR. DVRs are often integrated into set-top boxes used to process incoming video signals and to provide direct to disk recording capabilities that facilitate recording of broadcast television programs. DVRs can record video for playback in a digital format to a memory or other local or networked mass storage device.

Yet, recorded television programs often contain commercials, which a user viewing the timeshifted recorded television program may not wish to watch. Accordingly, software and other technological systems have been developed to play back recorded television programs while skipping, permitting fast-forwarding of, and/or otherwise omitting, the commercials. For example, some existing software solutions (e.g., third-party add-ons to a playback device) remove commercials/advertisements from recordings and can convert the recordings into different formats for viewing on different devices. However, omitting commercials tends to be disadvantageous to advertisers and can cause a user viewing the recorded television program to miss an offer in which he or she would otherwise have been interested.

### SUMMARY

Approaches presented herein enable representation of missed offers in a prerecorded video comprising a primary content and offer content that has been skipped by a user. More specifically, when the user plays the prerecorded video and initiates an action to skip the offer content, an offer representation tool identifies the subject matter of offers being skipped and generates an alternative representation of the skipped offer including a summary of the subject matter. The offer representation tool then displays the alternative representation of the offer to the user. The displaying the alternative representation can be based on whether a user profile, generated by the offer representation tool and describing preferences of the user, indicates that the skipped offer is potentially of interest to the user.

One aspect of the present invention includes a method for representing missed offers in a prerecorded video comprising a primary content and offer content, comprising: determining that a user has initiated an action to skip at least one advertisement of the offer content in the prerecorded video; identifying a subject matter of the at least one advertisement; generating an alternative representation of the advertisement indicating the subject matter of the at least one advertisement; and displaying the alternative representation of the advertisement to the user.

Another aspect of the present invention includes a computer system for representing missed offers in a prerecorded video comprising a primary content and offer content, the computer system comprising: a memory medium comprising program instructions; a bus coupled to the memory medium; and a processor, for executing the program instructions, coupled to an offer representation tool via the bus that when executing the program instructions causes the system to: determine that a user has initiated an action to skip at least one advertisement of the offer content in the prerecorded video; identify a subject matter of the at least one advertisement; generate an alternative representation of the advertisement indicating the subject matter of the at least one advertisement; and display the alternative representation of the advertisement to the user.

Yet another aspect of the present invention includes a computer program product for representing missed offers in a prerecorded video comprising a primary content and offer content, the computer program product comprising a computer readable storage device, and program instructions stored on the computer readable storage device, to: determine that a user has initiated an action to skip at least one advertisement of the offer content in the prerecorded video; identify a subject matter of the at least one advertisement; generate an alternative representation of the advertisement indicating the subject matter of the at least one advertisement; and display the alternative representation of the advertisement to the user.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments;

FIG. 2 shows a more detailed system architecture for identifying and representing bypassed offers in a prerecorded video according to illustrative embodiments;

FIG. 3 shows an illustrative example of using the system architecture of FIG. 2 to find advertisements of interest to a user according to illustrative embodiments;

FIG. 4 shows displaying alternative representation annotations of advertisements on a recorded video during fast-forwarding according to illustrative embodiments; and

FIG. 5 shows a process flowchart for representing missed offers in a prerecorded video comprising a primary content and offer content according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for representation of missed offers in a prerecorded video comprising a primary content and offer content that has been skipped by a user. More specifically, when the user plays the prerecorded video and initiates an action to skip the offer content, an offer representation tool identifies the subject matter of offers being skipped and generates an alternative representation of the skipped offer including a summary of the subject matter. The offer representation tool then displays the alternative representation of the offer to the user. The displaying the alternative representation can be based on whether a user profile, generated by the offer representation tool and describing preferences of the user, indicates that the skipped offer is potentially of interest to the user.

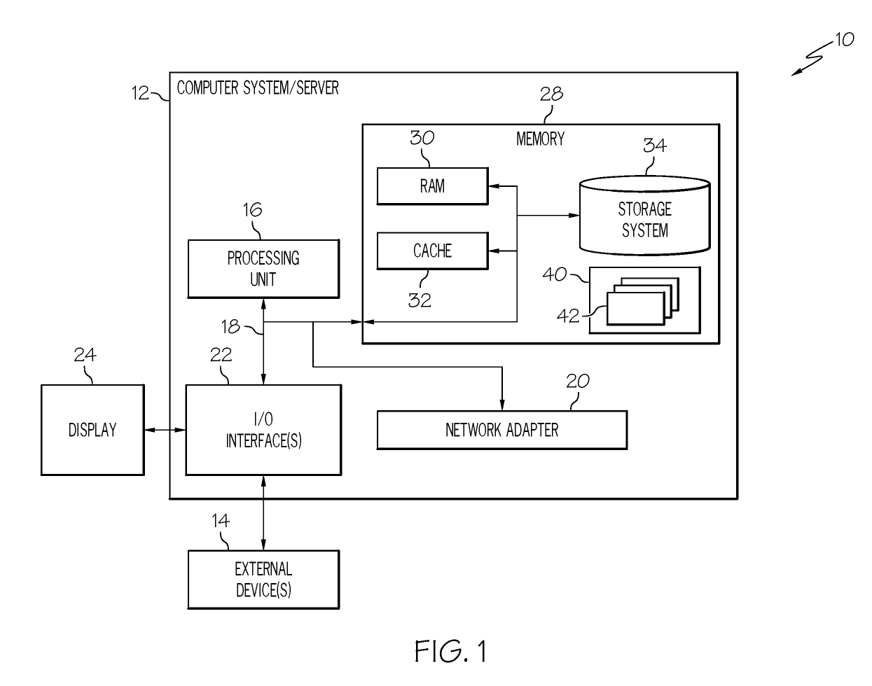

Referring now to FIG. 1, a computerized implementation 10 of an embodiment for representing missed offers in a prerecorded video will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein. Computer system/server 12 may be described in the general context of computer system/server executable instructions, such as program modules, being executed by a computer system. Generally, program modules may include routines, programs, objects, components, logic, data structures, and so on, that perform particular tasks or implement particular abstract data types. In this particular example, computer system/server 12 represents an illustrative system for representing missed offers in a prerecorded video. It should be understood that any other computers implemented under the present invention may have different components/software, but can perform similar functions.

Computer system/server 12 in computerized implementation 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for representing missed offers in a prerecorded video, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The inventors of the present invention have found that, while many people record television and other media programs for later viewing, they do not wish to watch the commercials also recorded along with (e.g., spliced between segments of) the program. Current systems and software add-ons for commercial skipping fail to provide a person viewing a prerecorded program with an opportunity to check if any of commercials, advertisements, promotions, or offers he or she missed when bypassing or forwarding through commercials are of interest to that person. Furthermore, current solutions fail to provide a viewer of a prerecorded program a summary of what commercials or particular commercials of interest played during a specific timeframe.

Accordingly, the inventors of the present invention have developed a system that identifies and represent commercials, advertisements, promotions, and/or offers a person viewing a prerecorded television or other media program and skipping the commercials misses but otherwise might have been interested in. Embodiments of the present invention include generally summarizing missed offers as well as specifically identifying and representing offers of particular interest to the viewer. Embodiments of the present invention offer several advantages. For instance, sometimes a person viewing a prerecorded program is in the market for an item or service or is planning on attending an event that might be advertised in one of the missed commercials. Embodiments of the present invention allow the person, who otherwise does not wish to watch the commercials during viewing of the prerecorded television program, to be notified of and provided an opportunity to watch a commercial for a good or service which the person has previously expressed an interest in or is specifically seeking.

Furthermore, embodiments of the present invention offer several advantages for improving video playing technology and computer systems for playing back video. In one instance, embodiments offer an efficient use of storage space on a video recorder or video player by minimizing portions of a recorded video containing advertising that are stored to only those that a user might wish to view. In another instance, embodiments offer a summary of advertisement content within a video, which allows a user or a video player system to determine whether to play the advertisement content of that video. In still another instance, embodiments offer providing a user with video advertising material through an alternative representation of the advertising material, such as a textual summary, thereby preempting the need for a video player to play advertisements and reducing a workload on the a video player.

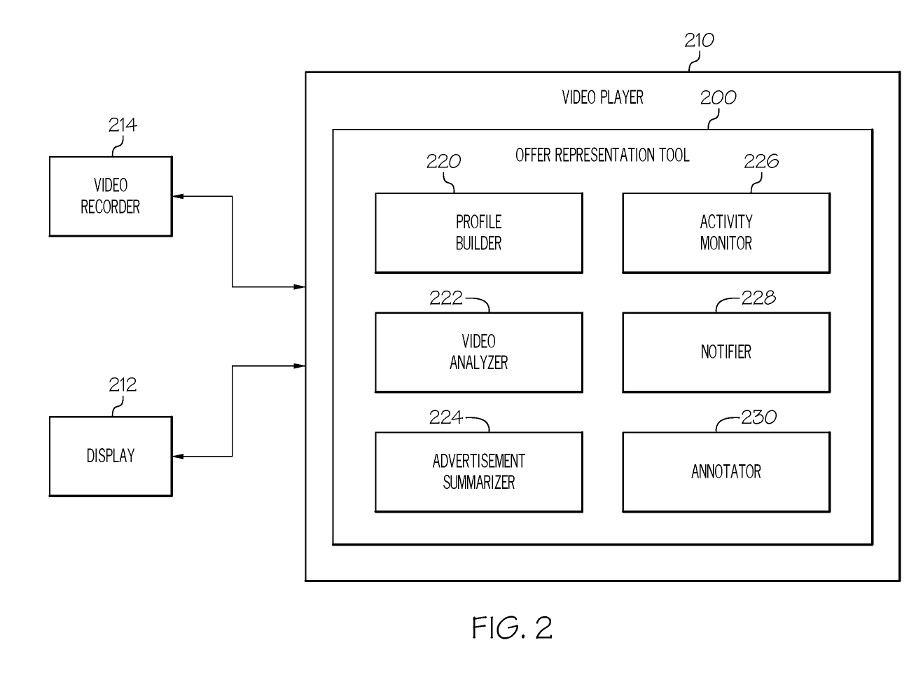

Referring now to FIG. 2, a more detailed system architecture for identifying and representing bypassed offers in a prerecorded video according to illustrative embodiments is shown. Computer system/server 12 (FIG. 1) can include or be included within any device for recording and/or playing recorded videos, such as video player 210. Video player 210 can include video playback controls such as play, stop, pause, rewind, and fast-forward. It should be understood that, although a video player device is presented in illustrative embodiments of the present invention, in some embodiments, computer system/server 12 can be any type of device capable of playing a recorded video, such as a personal computer, a personal device (e.g., a smartphone), a set-top box, a virtual video player stored in a cloud computing or networked computer environment, or any other video-playing device now known or later developed.

Video player 210 can be in communication with display 212 and/or video recorder 214. In some embodiments, display 212 and/or video recorder 214 can be part of the same device as video player 210, such as part of a smartphone or a DVR set-top box. Display 212 can be any visual display or screen used for viewing a video. Video recorder 214 can be any device capable of or any software for causing a device to make a recording (e.g., digital, analog) of a video. In some embodiments of the present invention, video recorder 214 can be programmed or otherwise instructed by a user to make a recording of a television program or other visual presentation, such as a video streamed from a web page. For example, a user may stream a video from a video streaming service, such as Ustream (registered trademark of Ustream, Inc., an IBM company). In some other embodiments of the present invention, a recording can be provided by an outside party, such as an online provider of videos for downloading to a personal computer or other user device.

Video player 210 can include offer representation tool 200. In some embodiments, offer representation tool 200 can be a program/utility 40 of FIG. 1. Offer representation tool 200 can contain a set of components (e.g., program modules 42 of FIG. 1) for carrying out embodiments of the present invention, including profile builder 220, video analyzer 222, advertisement summarizer 224, activity monitor 226, notifier 228, and annotator 230. Offer representation tool 200 can further be in communication with display 212 and/or video recorder 214. It should be understood that, although offer representation tool 200 is presented in illustrative embodiments of the present invention as located in video player 210, in some embodiments, offer representation tool 200 can be stored on another local device, a server, or remotely in a cloud storage environment.

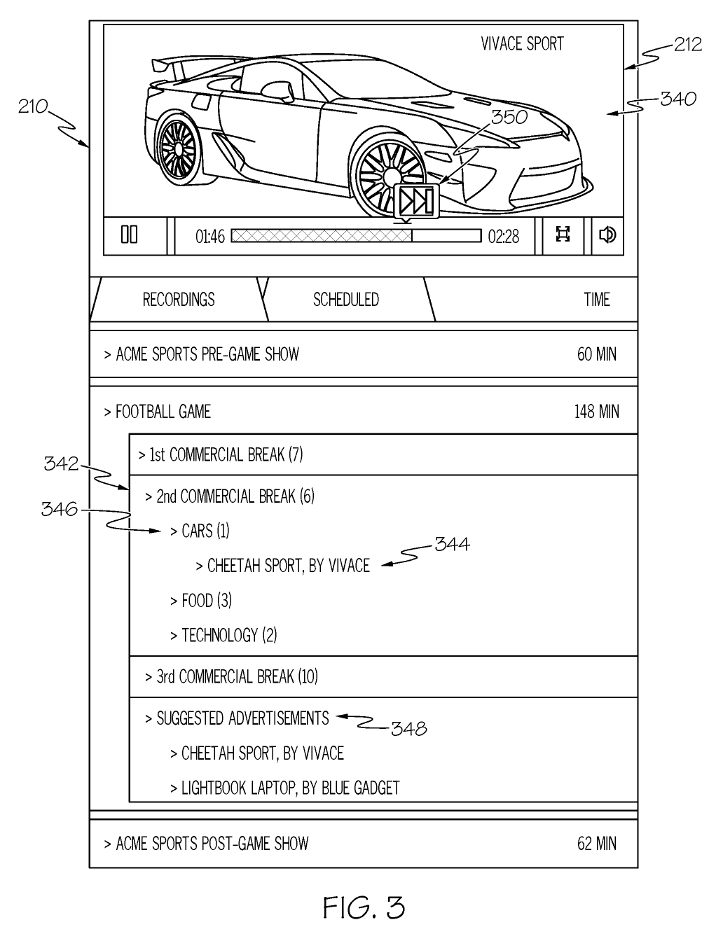

Referring now to FIG. 3 in connection with FIG. 2, an illustrative example of using offer representation tool 200 to find advertisements of interest to a user is shown. In this example, a user (also referred to here as the viewer) is viewing video 340 on video player 210. The user can control playback of video 340 using controls of video player 210 such as play/pause, stop, rewind, and fast-forward.

Offer representation tool 200 can generate a profile of the user with profile builder 220, which can gather information about the user to determine, among other things, preferences of the user. This information can be gathered from, among other places, social media data of the user (e.g., location, self-identified demographics, employment, hobbies, frequently discussed topics, “liked” items, followings, favorite popular culture items such as music and movies, friends and their interests, etc.), a search or browse history of the user (e.g., types of goods or services recently searched for or viewed), a purchase history (e.g., goods/services recently purchased from an online vendor) of the user, public records (e.g., marital status, home ownership, members of household), a financial institution used by the user (e.g., a purchase history on a credit card), etc. In some embodiments, offer representation tool 200 can reside in a smart TV in communication with one or more of these sources of information about the user.

Preferences of the user can include areas of interest (e.g., favorite restaurants), needs and wants (e.g., search history at vendor for a new mattress), upcoming events (e.g., social events from a user's calendar), preferences of others within the user's social circle (e.g., recommendations, endorsements, or likes from friends), family and co-habitants of the user (e.g., an elderly family member cared for by the user), and personal demographics (e.g. gender, age). In any case, profile builder 220 gathers information about the user that describes preferences of the user in a user preferences profile. Preferences described in the user preferences profile can include categories of interest (e.g., movies, celebrities, books, music, sports, restaurants), specific interests (e.g., jogging, sewing), demographics (e.g., location, employment, estimated income), and tastes of users (e.g., lifestyle, favorite color), and so forth.

In some embodiments, profile builder 220 can receive permission (e.g., by a sign-up, an opt-in, or an agreement to terms of service) from a user to monitor the user's activity (e.g., search and purchase history). In further embodiments, profile builder 220 can receive permission from a user to gather information about the user at an interval (e.g., periodically) or to receive pushed information from an information provider (e.g., a social media website) in response to an update at that information provider by the user.

In further embodiments, profile builder 220 can be configured to allow the user to build his or her own profile. For example, profile builder 220 can offer the user a selection of preference indicators to map areas of interest of the user. These preference indicators can include a set of categories, and optionally sub-categories, of goods and services that the user is interested in or would like to receive information about (e.g., upcoming movies, sales at retail locations, etc.). Furthermore, in some embodiments, profile builder 220 can receive instructions from the user to specifically show him or her advertising content from a specific source or vendor under specific conditions (e.g., any advertisements from the user's favorite restaurant in the case that the restaurant is running a promotional deal). In further embodiments, the preference indicators can include representative goods and services that profile builder 220 can use as a baseline for finding similar goods and services that the user might be interested in. For example, profile builder 220 could interpret a user selecting a smart watch representative item as indicating that the user would likely be interested in new releases of personal electronic devices.

In still further embodiments, profile builder 220 can also create a profile of dislikes or areas that a user would have little interest in, using methods like those discussed above to create a list of types of content that the user would most likely not wish to view. For example, if a user's social media account indicates that he or she does not have young children, then profile builder 220 can place goods or services for preschoolers on a list showing that the user has no interest in such and that advertisements for such should always be skipped. In further embodiments, profile builder 220 of offer representation tool 200 can act as a learning system. In such an embodiment, a user may indicate whether an alternative advertisement representation presented to him or her is actually of interest to him or her, and profile builder 220 can place the advertisement on a list or whitelist for reference in future commercial analyses.

Referring further to FIG. 3 in association with FIG. 2, a user may record video program 340 for later viewing using video recorder 214. Video recorder 214 can be set or programmed to record a particular show, movie, or other program at a specified time on a specified day. The recorded program can be any television program or video media from another source, such as a video streamed online. Once recorded video program 340 has been recorded by video recorder 214, video analyzer 222 can review recorded video program 340 to identify what portions of recorded video program 340 contain offer content, such as commercials, advertisements, paid programming, etc., and what portions of recorded video program 340 contain primary content, such as a television show, a movie, or other program. It should be understood that offer content refers to one or more advertisements, commercials, or other offers, containing information about an offer, presented as a video segment spliced or otherwise located between, proceeding, or succeeding segments of primary content as originally recorded by a video recorder. It should further be understood that primary content refers to a video-based entertainment program, such as, but not limited to, a video, a television show, or a movie.

In any case, video analyzer 222 can have the capability to distinguish between primary content and offer content. This capability can be based on, for example, object recognition, natural language recognition, a knowledge based system, detection of broadcast data distinguishing a television program and advertisements, and so forth. In one embodiment, video analyzer 222 can mark the portions of recorded video program 340 that contain advertisements by, for example, placing a time stamp at a beginning and at an end of a commercial segment.

Further, video analyzer 222 can identify individual advertisements in the offer content and determine a subject matter of each. It should be understood that subject matter refers to a topic of an advertisement, such as a product or service being offered for sale, and any information in the advertisement describing offer terms, such as a duration of sale or a scope of sales offer. Again, video analyzer 222 can use recognition technologies, such as object recognition, natural language recognition, voice to text processing, a knowledge based system, detection of broadcast, and so forth, to recognize the subject matter. In some embodiments, video analyzer 222 can categorize the subject matter of each advertisement. For example, during commercial break 342 (e.g., the second commercial break) of recorded video program 340 (e.g., a football game), video analyzer 222 can identify several commercials 344 (e.g., a commercial for a sports car) and their subject matter (e.g., Vivace offering end of the year sale on Cheetah model sports cars with 0% down and 0% interest until 2018 at select dealerships), and categorize that commercial into a category 346 (e.g., cars). In further embodiments, video analyzer 222 can further associate keywords with commercial 344 or apply some other associative analysis to commercial 344.

Video analyzer 222 can further use the user profile created by profile builder 220 to find commercials and/or advertisements that are potentially of interest to the user. This may be accomplished, for example, by matching a subject matter or category of a commercial to an area identified as of interest to the user in the profile based on sources such as social media data of the user, a search or browse history of the user, a purchase history of the user, public records, a financial institution used by the user, and so forth, as discussed further above. In further embodiments, this identifying of advertisements that are potentially of interest to the user can be accomplished by searching the identified advertisements for any that correspond to instructions from the user to specifically mark as being potentially of interest advertising content from certain sources or for certain goods or services.

In still further embodiments, video analyzer 222 can perform a ranking of the analyzed commercials to create a ranked list of commercials/advertisements that are most of interest to the user. This ranking can be based on the user profile and can use any methodology now known or later developed to identify items most closely related to a baseline profile. This ranking can also use a minimum threshold (e.g., measuring likeliness to be of interest to a user) as a lower cutoff of commercials/advertisements that may be presented in an alternative representation to the user. This minimum threshold may be set by the user or can be fixed by offer representation tool 200.

In yet another embodiment, video analyzer 222 can review the analyzed commercials/advertisements, and remove redundancies. For example, if during recorded video 340, the same commercial is played five times during various commercial breaks, all five instances need not be presented to the viewing user. Rather, a single instance of the commercial can be analyzed for compatibility with a potential interest of the user, and, if found to potentially be of interest, can be presented to the user.

In some embodiments, advertisement summarizer 224 can summarize all commercials identified in a prerecorded program, or merely those determined to be potentially of interest to the user. This summary can include a category of offering shown in each commercial (e.g., cars), a retailor, a logo or screenshot, a subject matter such as a short description of each commercial (e.g., Cheetah model sports car by Vivace), and/or a full description of each commercial such as offer details (e.g., end of the year Vivace sale with 0% down and 0% interest until 2018 at select dealerships), which can include quotations from the commercial converted from speech to text. In some embodiments, this summary can be a list of suggested commercials or advertisements 348 that can be presented to the user and can be ranked according to the ranking analysis described above. In still further events, the summary can be presented to the user as an alternative representation of the advertisement.

When the user plays back the particular show or program, activity monitor 226 can detect when the user fast-forwards 350 through commercials or skips commercials in another manner. This detection can trigger offer representation tool 200 to deliver a summary, a notification, communication (e.g., an on-screen annotation), or other alternative representation to the user regarding a fast-forwarded through or skipped commercial that may be of interest to the user, as will be discussed further below.

In some embodiments, the user may request a consolidated list or summary of any offers that were advertised in the skipped or fast-forwarded through commercials that he or she might be interested in (i.e., list of suggested commercials/advertisements 348). In other words, the user may indicate that, while he or she does not wish to view or even include commercials in a recording, he or she would like a summary of advertisements that were shown during the original broadcast. In further embodiments, the user may specify that he or she would only like a summary, based on the user's profile, of advertisements that are potentially of interest to him or her. In still further embodiments, the user may indicate specific instructions of what types of advertisements are to be included in the summary for a particular recording.

In some embodiments, this consolidated list or summary of suggested commercials/advertisements 348 can be presented to the user by notifier 228 in the same viewing pane (i.e., display/screen 212) that is showing playback of the prerecorded program. Suggested commercials/advertisements 348 can be presented as an overlay (e.g., during playback of the television program), as part of a menu displayed by video player 210, etc. Further, notifier 228 can present list or summary of suggested advertisements 348 to the user on a device that is separate from video player 210. For example, the list can be sent to a mobile device of the user through, for example, an email, a SMS message, a notification within an application linked to video player 210, and/or offer representation tool 200, and so forth.

In some embodiments, this notification can take place through an alternative representation of an advertisement while the user is watching a playback of the recorded program. More specifically, the notification can be triggered in response to the user fast-forwarding 350 through commercials or otherwise skipping, omitting, or bypassing commercials, as detected by activity monitor 226. In still further embodiments, the user can request and/or receive the notification before or after watching a prerecorded program. For example, summary 348 can be presented at the end of the prerecorded program. In some embodiments, the user may configure what content is shown to the user in this summary. For example, the user can choose to view advertising summaries of all advertisements and offers that were presented during a certain period or merely a filtered set of advertisements based on the profile of the user.

In some embodiments, the notification and/or summary 348 can permit interaction by the user with the alternative representation and/or the advertisements represented in the summary. For example, the user may choose to rewind to a location of an advertisement presented in the alternative representation or may click on or select the advertisement in the alternative representation and jump to that advertisement. This interaction can take place a number of ways, including, for example, through a remote control, a voice command, and/or gestures or movement of the user in a system having a camera or sensor to detect gestures or movement by the user.

In still further embodiments, one or more advertisements of interest can be played for a user at a beginning of or at an end of prerecorded video 340. For example, a user may be required to watch a certain number of advertisements before being able to access prerecorded video 340. In such embodiments, offer representation tool 200 can select the advertisements most likely to be of interest to the user to require the user to watch.

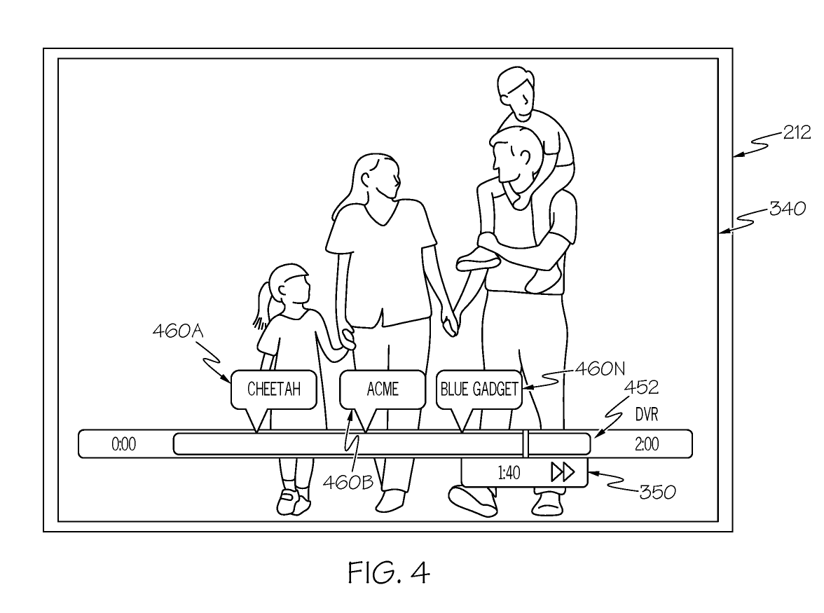

Referring now to FIG. 4 in connection with FIG. 2 and FIG. 3, displaying alternative representation annotations 460A-N of advertisements on top of recorded video 340 during fast-forwarding 350 is shown. In some embodiments, notifier 228 prompts annotator 230 to create and display at least one alternative representation annotation 460N on display 212 playing back recorded video 340. Alternative representation annotation 460N can include an alert, a logo, a screenshot, or other thumbnail representing or indicating a subject matter of at least one advertisement found in the prerecorded program that video analyzer 222 determines to potentially be of interest to the user. Annotator 230 can present alternative representation annotations 460A-N as popups, markers on video progress bar 452, or any other type of notification in video 340 on display 212. For example, alternative representation annotations 460A-N can be icons, representing each advertisement, place on video progress bar 452 of prerecorded video 340 at locations representing a time of each advertisement.

In some embodiments, a user may opt into receiving summaries and notifications from offer representation tool 200. A user may choose to opt into this as part of an agreement with a cable/television company or other video provider. Further, such cable/television companies or other video providers may offer services to provide users with summaries and notifications from offer representation tool 200 as an alternative to users simply fast-forwarding or outright skipping through commercials. As can be seen from the discussion above, embodiments of the present invention provide a user with an alternative representation, which can include a summary, of commercials/advertisements/offers that are otherwise skipped during the watching of a prerecorded video program and, by extension, provide advertisers with a greater possibility that a user will be made aware of advertised offers. Accordingly, embodiments of the present invention allow a user to have awareness of and take advantage of offers, without having to watch the advertisements presenting the offers between segments of a prerecorded television or video program.

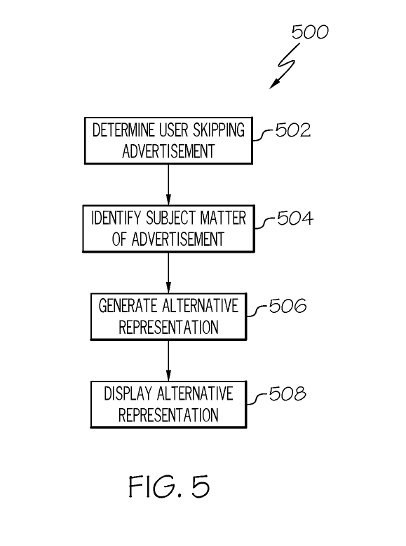

As depicted in FIG. 5, in one embodiment, a system (e.g., computer system/server 12) carries out the methodologies disclosed herein. Shown is a process flowchart 500 for representing missed offers in a prerecorded video comprising a primary content and offer content. At 502, offer representation tool 200 determines that a user has initiated an action to skip at least one advertisement of the offer content in the prerecorded video. At 504, offer representation tool 200 identifies a subject matter of the at least one advertisement. At 506, offer representation tool 200 generates an alternative representation of the advertisement indicating the subject matter of the at least one advertisement. At 508, offer representation tool 200 displays the alternative representation of the advertisement to the user.

Process flowchart 500 of FIG. 5 illustrates the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for representing missed offers in a prerecorded video. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for representing missed offers in a prerecorded video. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches to representing missed offers in a prerecorded video. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

1. A method for representing missed offers in a prerecorded video comprising a primary content and offer content, comprising:
determining that a user has initiated an action to skip at least one advertisement of the offer content in the prerecorded video;
categorizing a subject matter of the at least one advertisement into at least one category;
generating an alternative representation of the advertisement, the alternative representation comprising a textual summary of the at least one advertisement and indicating the category of the subject matter of the at least one advertisement; and
displaying the alternative representation of the advertisement to the user.

2. The method of claim 1, wherein the prerecorded video is shown on a display screen and the method further comprises displaying, on the display screen, the alternative representation of the advertisement indicating the subject matter of the at least one advertisement.

3. The method of claim 2, wherein the alternative representation of the advertisement comprises an icon on a progress bar of the prerecorded video at a location representing a time of the at least one advertisement.

4. The method of claim 1, the method further comprising:
generating a profile of one or more preferences of the user based on user preferences gathered from at least one source selected from the group consisting of: a social media account of the user, a search history of the user, a browser history of the user, a purchase history of the user, a public record of the user, and a financial institution associated with the user; and
displaying the alternative representation of the advertisement to the user based on the profile of preferences of the user.

5. The method of claim 4, the method further comprising:
comparing the identified subject matter of the at least one advertisement to one or more user preferences of the profile;
in the case that the identified subject matter corresponds above a predetermined threshold to a user preference of the user preferences profile, performing the generation and the displaying of the alternative representation of the advertisement; and
in the case that the identified subject matter does not correspond above the predetermined threshold to user preference of the user preferences profile, suppressing the generation and the displaying of the alternative representation of the advertisement.

6. The method of claim 4, wherein the one or more user preferences comprises at least one item selected from the group consisting of: a user interest, a need of the user, a want of the user, an event of the user, a recommendation from a friend of the user, and a social media profile of the user.

7. The method of claim 1, wherein the alternative representation of the advertisement comprises a summary of the subject matter of the advertisement which comprises at least one of the group consisting of: a category, a retailor, a description, and offer terms, of the at least one advertisement.

8. The method of claim 1, wherein the action comprises fast-forwarding through the at least one advertisement.

9-20. (canceled)
